(19) United States
(12) Patent Application Publication
(10) Pub. No.: US 2021/0251255 A1
(43) Pub. Date: Aug. 19, 2021

(54) GELATIN-FREE GELLED CONFECTIONERY AND METHOD FOR PREPARING SUCH A CONFECTIONERY

(71) Applicant: ROQUETTE FRERES, Lestrem (FR)

(72) Inventor: Sylvie LAGACHE, MARCQ EN BAROEUL (FR)

(21) Appl. No.: 16/973,363

(22) PCT Filed: Jun. 14, 2019
(86) PCT No.: PCT/FR2019/051445

§ 371 Date: Dec. 8, 2020

(30) Foreign Application Priority Data
Jun. 15, 2018 (FR) 1855289

(51) Int. Cl. A23G 3/42; A23G 3/34; A23G 4/10; A23G 4/04

(52) U.S. Cl. CPC A23G 3/42; A23G 3/0019; A23V 2002/00; A23G 4/04; A23G 4/10

(57) ABSTRACT

The present invention relates to a novel gelatin-free gelled confectionery comprising 2% to 4% of pregelatinized waxy starch and 0.5% to 1.5% of branched maltodextrins, wherein the percentages are expressed in dry weight relative to the total weight of the final product. The invention also relates to a method for preparing such a confectionery.

### FIELD OF THE INVENTION

The present invention relates to a novel gelled confectionery, more particularly a soft candy or a chewing paste comprising a gelatinizing agent and a soluble fiber which give said candies their excellent chewability, in terms of hardness and elasticity.

The present invention also relates to a process for preparing such a confectionery.

### TECHNOLOGICAL BACKGROUND

There are numerous confectionery products. They all have in common the boiling of sugar and the mixing thereof with other ingredients in order to obtain different specialty products and flavors.

For the purposes of the present invention, the term “gelled confectionery” means chewing pastes and jellies, which belong to soft articles compared with hard boiled candies, and also caramels, toffees, fudges, pastilles, fondants and fillings conventionally containing gelatin.

These confectioneries consist in particular of sugars or polyols, sweeteners, fats, emulsifiers, flavorings, colorings, mineral and/or organic acids and/or bases and salts thereof and one or more thickening and/or gelling hydrocolloids of vegetable or animal origin, such as gum arabic, gelatin, pectin, carrageenans, alginates, celluloses and starch.

There are no precise definitions of these various gelled confectioneries, which can be arbitrarily classified as hard gums and soft gums.

Soft gums more particularly include jellies and gums (“jelly beans”, “wine gums”), conventionally prepared based on gelatin and/or starch used as gelling agent and providing the required elasticity for these soft articles, of elastic to plastic texture.

Chewing pastes are obtained by boiling a mixture of sugar and glucose syrup, to which a small amount of fat has been added.

The boiled mass is then aerated in order to lighten it by means of one of the processes well known to confectioners, for instance pulling, beating, optionally under pressure, mixing under pressure, or extrusion.

It is this aeration and the presence of fats which give chewing pastes their characteristic texture.

The present invention also relates to caramels, toffees, fudges, pastilles and fillings conventionally containing gelatin.

The composition of the caramels, toffees and fudges can vary to a large extent depending on the desired strength of color and taste and also the desired texture.

Generally, the residual moisture content of such products varies between 3% and 10%, sucrose between 30% and 60%, invert sugar between 1% and 10%, glucose syrup (expressed on a dry basis) between 20% and 50%, fats between 1% and 15%, lactose between 1% and 6% and milk proteins between 0.75% and 15%.

Technologically, it is possible to classify these specialty products in three main groups according to their residual moisture content and their texture.

Hard caramels have a residual moisture content of 3% to 4% and a hard and smooth texture, whereas soft caramels/toffees have a relative moisture content of 7% to 10% and a soft and chewy texture, and fudges have a residual moisture content of 7% to 9% for a soft but short texture.

The names “(soft or hard) caramels” and “toffees”, possibly accompanied by a description, are reserved for confectioneries prepared by boiling sugar, glucose (or invert sugar), dietary fats (butyric fat, vegetable fat and/or animal fat) and milk proteins, the fats and the milk proteins having to be in proportions such that the final product contains at least 6% of fats and 6% of solids originating from milk.

Fatty fillings are all mixtures obtained from sugar, or from any other bulk sweetener, for instance polyols, and from vegetable and/or animal fats, which conventionally contain milk proteins and which are intended to be used as filling in confectionery, cake production, the bakery trade, the cookie trade and any other area of food production. Such examples are, for example, praline-flavored fatty fillings and imitation “chocolate” fatty fillings.

The gelatin used in all these gelled confectioneries is an animal protein extracted, after partial hydrolysis, from raw materials rich in collagen extracted from skin, bone, cartilage, ligaments, etc.

Gelatin produced from fish also exists, but it represents only a very small percentage of the food gelatin produced today in Europe (less than 3%).

Once it is ready to use, gelatin is a translucent, transparent or slightly yellow solid substance which has a characteristic odor and taste.

Gelatin is widely used in the confectionery field. It is its elasticity that is highly appreciated because it provides a very particular sensation upon chewing.

Moreover, it has excellent flavor-releasing abilities, hence its value for producing delicious confectioneries. Finally, it is capable of absorbing five to six times its weight in water. It is therefore widely used because it has many functional advantages. It is used primarily as a gelling agent, but also as a thickener, stabilizer, emulsifier, binder and foaming agent in aerated confectionery.

For many years, gelatin has hardly had good press. Following the emergence of bovine spongiform encephalitis, the use of gelatin in food preparations is today very controversial.

In addition, in the confectionery field, only gelatin derived from pig skins is used, which can also pose problems with respect to certain beliefs or religions.

Finally, vegetarians and vegans also refuse to consume any animal-derived products and consequently boycott all confectionery products containing gelatin.

Furthermore, because of its taste and its particular odor, its use very often forces manufacturers to use flavors in order to mask its presence and its olfactory drawbacks.

Gelatin also has a high cost price which can curb its use, especially for emerging countries.

Furthermore, gelatin is a protein that is highly sensitive to extreme pH and temperature conditions (highly acidic pHs, very high temperatures) in which it has a tendency to degrade, thus losing its gelling properties.

Very many research studies have been carried out in order to propose more or less complex solutions for totally or partially replacing gelatin in the production of gelled confectionery, in particular gelled gums. In particular, gelled confectioneries based on various starches are known.

Those skilled in the art know, moreover, that only amylose acts as a gelling agent, that amylopectin confers elasticity on products but gels more slowly and increases viscosity much more than amylose, and that amylose gives opaque gels whereas amylopectin gives transparent products.

It has therefore been proposed, in documents EP 0 252 306 B1 and EP 0 360 046 B1, to mix various modified or unmodified high-amylose starches so as to combine the properties thereof. These solutions require mixtures of several starches and are not necessarily simple to use industrially speaking.

Document EP 1 342 417 A, of which the applicant company is the proprietor, describes a gelled confectionery containing a waxy starch in combination with carrageenans. The confectioneries obtained are of satisfactory quality but do not equal the properties of the confectioneries obtained with gelatin, and the solution proposed imposes the use of carrageenans which are expensive.

Moreover, although this solution provides satisfactory results for gelled gums, it is not satisfactory for chewing pastes.

Document EP 1 645 196 B, of which the applicant company is also the proprietor, describes gelled confectionery products based on fluidized and stabilized pulse starch having a very specific amylose content.

Finally, document EP 2 919 589 A, of which the applicant company is also the proprietor, describes the use of a pregelatinized waxy starch to replace gelatin in gelled confectionery, while preserving the organoleptic qualities, in particular gustative, olfactory, visual and tactile properties, at least equivalent to or even greater than those of the conventional confectioneries containing gelatin.

Thus, the confectionery products prepared according to the teaching of this patent application EP 2 919 589 A retain a texture, a chewability, a duration in the mouth and a palatability that are at least similar, or even improved, compared with the confectioneries conventionally comprising gelatin. The gelatin may be partially or totally replaced.

Preferably, it is recommended to prepare this gelled confectionery comprising a pregelatinized waxy starch with at least one other ingredient chosen from branched maltodextrins (sold by the applicant company under the brand name NUTRIOSE®), sorbitol and glycerin, in particular proportions.

Still in this patent application EP 2 919 589 A, the best gelled confectionery recipes proposed by the applicant company, giving said candies their excellent chewability, in terms of hardness and elasticity, were obtained by the combination:
of 2% to 10%, even more preferably 4% to 8%, of pregelatinized waxy starch,
preferably of 2% to 10%, even more preferably 4% to 8% of branched maltodextrins,

the percentages being expressed by weight relative to the total weight of the confectionery.

It was even recommended to select, in one advantageous embodiment, a confectionery comprising from 50% to 75%, preferably from 56% to 62% of branched maltodextrins, which furthermore enabled the gelled confectionery thus obtained to be described as “high fiber”.

Those skilled in the art of confectionery thus deduce from the teaching of this document that, for an optimized content of pregelatinized waxy starch used as a gelatin substitute in gelled confectioneries, i.e. at a value of between 4% and 8% by weight relative to the total weight of the confectionery, it was preferably necessary to choose a degree of incorporation of branched maltodextrins of between 2% and 10%, and preferably from 4% to 8% by weight relative to the total weight of the confectionery.

No impact study on the acceptability of a gelatin-free gelled confectionery had been carried out for a degree of incorporation of branched maltodextrins of less than 2%.

Although satisfactory, all of the ways proposed and described in the prior art for replacing gelatin totally or partly in gelled confectioneries do not completely make it possible to obtain textures comparable to standard gelled confectioneries containing gelatin.

There is therefore still a need for an alternative recipe that makes it possible to completely replace gelatin in the gelled confectioneries and to provide a texture in the mouth having optimum hardness and elasticity.

It is thus to the credit of the applicant company to have identified that small amounts of branched maltodextrins and pregelatinized waxy starch made it possible to obtain such a gelled confectionery having a satisfactory texture with an optimal balance between the hardness and the elasticity obtained, i.e. a gelled confectionery having a good firmness while preserving the elasticity required for chewing.

### SUMMARY OF THE INVENTION

A first subject of the invention therefore relates to a gelatin-free gelled confectionery comprising:
from 2% to 4% of pregelatinized waxy starch,
from 0.5% to 1.5% of branched maltodextrins,

the percentages being expressed by dry weight relative to the total weight of the final product.

The gelled confectionery according to the invention thus has a satisfactory texture with in particular an optimal balance between the hardness properties and the elasticity properties.

A second subject of the invention relates to a premix consisting of pregelatinized waxy starch and branched maltodextrins, said premix being characterized in that it comprises a pregelatinized waxy starch/branched maltodextrins weight ratio of 1 to 8. The premix according to the invention finds a very particular use in the manufacture of gelatin-free gelled confectioneries.

A third subject of the invention relates to a process for preparing gelatin-free gelled confectioneries comprising the steps of:
preparing a mixture comprising:
   from 2% to 4% of waxy starch,
   from 0.5% to 1.5% of branched maltodextrins,
   at least one sweetener and water,
cooking said mixture at a temperature of between 100° C. and 150° C. until the desired solids content is obtained,
shaping the cooked mixture so as to obtain said gelled confectioneries.

### DETAILED DESCRIPTION

A first subject of the invention therefore relates to a gelatin-free gelled confectionery comprising:
from 2% to 4% of pregelatinized waxy starch,
from 0.5% to 1.5% of branched maltodextrins,

the percentages being expressed by dry weight relative to the total weight of the final product.

Contrary to the teaching of patent application EP 2 919 589 A, the applicant company has now found that it is no longer necessary to prefer to use between 2% and 10%, preferably from 4% to 8% by weight of branched maltodextrins to obtain a satisfactory texture of the gelatin-free gelled confectionery in recipes comprising less than 4% by weight of pregelatinized waxy starch.

In fact, surprisingly, small amounts of branched maltodextrins and pregelatinized waxy starch make it possible to obtain a gelled confectionery having a satisfactory texture and above all an optimal balance between hardness and elasticity.

This optimal balance of the hardness and elasticity of the gelled confectionery according to the invention thus results in a hardness of from 6 to 8 N and an elasticity of from 7% to 9%.

With such properties, the gelled confectionery exhibits good firmness while preserving the elasticity required for chewing.

The hardness and elasticity measurements are carried out at a temperature of 20° C. on an INSTRON 5966 texturometer with a “finger punch” type geometry and by imposing a deformation at 30% of the height of the sample for 2 minutes and a test speed of 10 mm/min.

According to the present invention, the expression “gelled confectionery” should be interpreted as denoting all confectioneries usually containing gelatin.

They are, inter alia, hard gums, soft gums, chewing pastes, licorices, jellies, pastilles, fruit pastes, caramels, toffees, fondants, fudges and fillings, lozenges, and also inclusions for ice creams or pastries, or else any of the confectioneries of the same type which are termed pharmaceutical and which contain an active principle for example. All these articles belong to soft articles compared with boiled sugars.

In one preferred embodiment of the present invention, the gelled confectioneries are chewing pastes which are very well-liked by consumers because of their considerable chewability property making them similar to a chewing gum.

For the purposes of the present invention, the expression “waxy starch” denotes all starch varieties containing an amylopectin content greater than or equal to 80%, preferably greater than or equal to 90% and even more preferably greater than or equal to 95%.

For the purposes of the present invention, said waxy starch is derived from one or more botanical varieties chosen from corn, rice, potato and wheat, and any mixtures thereof. According to the present invention, the botanical varieties may be wild-type or hybrid and therefore may have undergone genetic modifications in order to modify their genome.

In the present invention, the terms “pregelatinized waxy starch” and “precooked waxy starch” are used without implied distinction to denote any waxy starch having undergone a heat treatment in the presence of water, such that it loses virtually its entire granular structure and becomes soluble in cold water.

Thus, for the purposes of the invention, the term “pregelatinized waxy starch” or “precooked starch” is intended to mean a state in which the starch is virtually no longer in a granular state, i.e. in a state in which it is no longer in the form of semi-crystalline granules characteristic of the state in which it is naturally present in the storage organs and tissues of higher plants, in particular in the seeds of cereals, the seeds of leguminous plants, the tubers of potato or of cassava, the roots, the bulbs, the stems and the fruits. This semi-crystalline state is essentially due to the macromolecules of amylopectin, one of the two main constituents of starch.

In the gelled confectionery according to the invention, the waxy starch can be used in the form of pregelatinized waxy starch or also in the form of native waxy starch, the gelatinization then taking place during the process for manufacturing the gelled confectionery.

Indeed, the gelatinization of the waxy starch can be obtained prior to the preparation of the gelled confectionery by supplying a pregelatinized waxy starch or during the preparation as is.

The choice of gelatinizing the waxy starch prior to its use or during the confectionery manufacturing process is based on the choice of the cooker used in the cooking step.

The use of cookers at atmospheric pressure or with short cooking times allows the preparation of pregelatinized waxy starch as is, which can be incorporated directly into the confectionery.

However, as some cookers cannot operate with high viscosities (such as plate heat exchangers), the already cooked waxy starch (pregel) is then added.

Therefore, if the type of cooker allows it, a person skilled in the art may advantageously prefer to use waxy starch in its native form, and carry out the cooking thereof, for example in the presence of the other confectionery ingredients as described below, in order to break the starch grain while concentrating the syrup to the solids content necessary for a satisfactory texture.

The pregelatinized waxy starches according to the present invention can for example be obtained by hydrothermal gelatinization treatment of native starches, in particular by steam cooking, cooking with a jet-cooker, cooking on a drum, cooking in blender/extruder systems or microwave systems followed by drying, for example in an oven, with hot air on a fluidized bed, on a rotating drum, by atomization, by extrusion or else by lyophilization.

Such starches generally have a solubility in demineralized water at 20° C. of greater than 5% and more generally between 10% and 100% and a degree of starch crystallinity of less than 15%, generally less than 5% and usually less than 1%, or even zero. By way of example, mention may be made of the products manufactured and sold by the applicant company under the brand name PREGEFLO®.

The gelled confectionery according to the invention also comprises from 0.5% to 1.5% of branched maltodextrins. Preferably, the gelled confectionery comprises from 0.5% to 1% of branched maltodextrins, and very particularly about 1% of branched maltodextrins. All percentages are expressed by dry weight of product relative to the total weight of the confectionery.

For the purposes of the invention, the term “branched maltodextrins” is intended to mean the specific maltodextrins identical to those described in patent EP 1 006 128 B1 of which the applicant company is the proprietor.

These branched maltodextrins have the advantage of representing a source of indigestible fibers beneficial to the metabolism and to intestinal equilibrium.

According to the present invention, said branched maltodextrins may have:
between 15% and 50% of 1-6-glucosidic linkages, preferentially between 22% and 45%, more preferentially between 20% and 40%, and even more preferentially between 25% and 35%,
a reducing sugar content of less than 20%, preferentially between 2% and 20%, more preferentially between 2.5% and 15%, and even more preferentially between 3.5% and 10%,
a polydispersity index of less than 5, preferentially of between 1 and 4, more preferentially between 1.5 and 3, and
a number-average molecular mass Mn of less than 4500 g/mol, preferentially between 400 and 4500 g/mol, more preferentially between 500 and 3000 g/mol, more preferentially between 700 and 2800 g/mol, even more preferentially between 1000 and 2600 g/mol.

According to a particular embodiment, the branched maltodextrins of the gelled confectionery have between 15% and 35% of 1-6-glucosidic linkages, a reducing sugar content of less than 20%, a weight-average molecular mass Mw of between 4000 and 6000 g/mol and a number-average molecular mass Mn of between 250 and 4500 g/mol.

Certain branched maltodextrin subfamilies described in the abovementioned application can also be used in accordance with the invention. These are, for example, high-molecular-weight branched maltodextrins having a reducing sugar content at most equal to 5 and a number-average molecular mass Mn of between 2000 and 4500 g/mol. Low-molecular-weight branched maltodextrins having a reducing sugar content of between 5% and 20% and a number-average molecular mass Mn of less than 2000 g/mol can also be used.

According to one particularly advantageous embodiment of the present invention, the branched maltodextrin is derived from the NUTRIOSE® range, which is a complete range of soluble fibers, recognized for their benefits, and manufactured and sold by the applicant company.

The products of the NUTRIOSE® range are partially hydrolyzed wheat or corn starch derivatives which contain up to 85% of fiber. This richness in fibers makes it possible to increase digestive tolerance, to improve calorie control, to prolong energy release and to obtain a lower sugar content. Furthermore, the NUTRIOSE® range is one of the best tolerated fibers available on the market. It shows a higher digestive tolerance, enabling better incorporation than other fibers, which represents real dietary advantages.

There are many advantages of branched maltodextrins such as NUTRIOSE® in the gelled confectionery of the present invention.

In addition to the nutritive aspect and the provision of fibers that are very well-tolerated by the organism, the branched maltodextrins from this range also have a not insignificant technical value. This is because they consist of long polymeric glucidic chains and thus act as a texturizing agent in the confectioneries.

The presence of branched maltodextrins thus further makes it possible to increase the elasticity of the final product. Thus, the durability of the chewability is increased by the presence of these long chains which modify the texture of the product. Their branched nature considerably and advantageously decreases their tendency to retrograde, which represents an advantage for gelled confectioneries where the absence of retrogradation is necessary, in particular during prolonged storage.

The presence of branched maltodextrins also makes it possible to increase the glass transition temperature or Tg of the amorphous portion of said confectionery. This increase in the Tg makes it possible to stiffen the structure within the confectionery and consequently makes it possible to introduce good chewability strength.

As will be exemplified below, the applicant company has demonstrated that a degree of incorporation of branched maltodextrin of 0.5% to 1.5%, more preferentially of the order of 1%, with from 2% to 4% of pregelatinized waxy starch was sufficient to obtain an optimal balance between hardness and elasticity. The gelled confectionery according to the invention thus comprises an intermediate hardness of from 6 to 8 N and an average elasticity of from 7% to 9% and thus exhibits good firmness while preserving the elasticity required for chewing.

The gelled confectionery according to the invention thus comprises a pregelatinized waxy starch/branched maltodextrins weight ratio of from 1 to 8. Preferably, the pregelatinized waxy starch/branched maltodextrins weight ratio is from 2 to 6, more preferably from 3 to 5, and very particularly, it is approximately 4.

Another particularly advantageous property of the present invention is that the various constituents used, namely the pregelatinized waxy starch and the branched maltodextrins, do not need to be hydrated before they are incorporated, unlike gelatin. The use thereof is therefore simpler.

Moreover, this gelatin hydration step was a critical step of the process for producing confectioneries since it comprises a considerable risk of introducing bacteria into the preparations. Indeed, gelatin is an excellent support for bacterial growth.

The gelled confectioneries according to the present invention are therefore found to also be more hygienic since they have a lower bacterial load.

According to one particular embodiment, the gelled confectionery according to the invention also comprises a water activity regulating agent or depressant chosen from sorbitol and glycerol, and mixtures thereof. According to this embodiment, the confectionery comprises from 0.1% to 15% of a water activity regulating agent or depressant, preferably from 1% to 8%, even more preferably 2% to 6%, the percentages being expressed by dry weight relative to the total weight of the confectionery.

The water activity or aw represents the amount of free water available within a food for any subsequent biochemical reactions. It does not represent the water content (or moisture content), but indeed the availability of this water.

Furthermore, it directly determines the physical, mechanical, chemical and microbiological properties of numerous substances, such as, inter alia, the fluidity, coagulation, cohesion and static electricity. The storage capacity of foods, the color stability, the taste stability, the vitamin content, the flavor and the conditions favorable to mold formation and to microbe growth are directly influenced by the aw value. Thus, the fact of adding a regulating agent, notably sorbitol, makes it possible to reduce the aw in the gelled confectioneries of the present invention, and therefore makes it possible to preserve the elastic texture and the chewability of said confectioneries by stabilizing the water that they contain.

Indeed, the gelled confectioneries of the present invention have the particularity of having an aw that is lower than the aw conventionally measured in gelled confectioneries usually containing gelatin.

According to another particular embodiment, the gelled confectionery can also comprise glucose syrups. In the present application, the glucose syrups are the products of hydrolysis of starch having a DE (Dextrose Equivalent) greater than 20. The term “hydrolysis of starch” is intended to mean any process of acid or enzymatic hydrolysis of starch from leguminous plants, from cereals or from tuberous plants. Various hydrolysis methods are known and have been generally described on pages 511 and 512 of the Encyclopedia of Chemical Technology by Kirk-Othmer, 3rd Edition, Vol. 22, 1978.

According to another particular embodiment, the gelled confectionery also comprises one or more sweeteners. Various sweeteners can be used, such as sugars or polyols, in powder or syrup form.

The sugars are chosen from the group made up of monosaccharides, disaccharides, trisaccharides, oligosaccharides and polysaccharides, such as, for example, glucose syrups, glucose-fructose syrups, fructose-glucose syrups, high-maltose glucose syrups, sucrose, fructose, maltose, trehalose, mannose, dextrose, tagatose or isomaltulose, alone or as a mixture with one another.

The polyols are preferentially chosen from the group made up of maltitol, mannitol, erythritol, xylitol, iditol, maltitol syrups, isomalt, lactitol, and hydrogenated glucose syrups, alone or as a mixture with one another. Use may also be made of strong sweeteners of any type, such as, for example, saccharine, aspartame, or acesulfame K, used alone or as synergistic mixtures. Advantageously, sorbitol is not used as sweetener in the confectionery according to the invention.

The sweetener preferably represents 25% to 85%, preferably 40% to 85% and more preferentially still 60% to 85% by weight relative to the total weight of the gelled confectionery.

According to another particular embodiment, the gelled confectionery may also comprise one or more compounds chosen from non-reducing sugars, fats, emulsifiers, preservatives, overrun agents, foaming agents, gelling agents, humectants, acidifying agents, natural or synthetic flavors, flavor enhancers, vitamins, pharmaceutical active agents, minerals such as calcium or magnesium and other food supplements such as, for example, DHA, natural or synthetic colorings, salts, acids, or various elements intended either to improve the quality, or to flavor the composition, such as dry fruits, candied fruits, fruits which have been dried or otherwise transformed (pressed, concentrated, powdered), and also fruit purees and fruit pulps, which are generally present in said confectionery in an amount of 0% to 30% by weight relative to the total weight of the confectionery.

A second subject of the invention relates to a premix consisting of pregelatinized waxy starch and branched maltodextrins, said premix being characterized in that it comprises a pregelatinized waxy starch/branched maltodextrins weight ratio of from 1 to 8. Preferably, the pregelatinized waxy starch/branched maltodextrins weight ratio is from 2 to 6, more preferably from 3 to 5, and very particularly, it is approximately 4.

The premix according to the invention finds a very particular use in the manufacture of gelatin-free gelled confectioneries as described above.

A third subject of the invention relates to a process for preparing gelatin-free gelled confectioneries comprising the steps of:
preparing a mixture comprising:
   from 2% to 4% of waxy starch,
   from 0.5% to 1.5% of branched maltodextrins,
   at least one sweetener and water,
cooking said mixture at a temperature of between 100° C. and 150° C. until the desired solids content is obtained,
shaping the cooked mixture so as to obtain said gelled confectioneries.

The percentages are expressed by dry weight relative to the total weight of the final product.

The pregelatinized waxy starch and branched maltodextrins are as defined above.

The sweeteners are also as defined above and represent preferably from 25% to 85%, more preferably from 40% to 85%, and more preferentially still from 60% to 85% by dry weight relative to the total weight of the final product.

The first step of the process according to the invention therefore consists in preparing a mixture based on waxy starch, branched maltodextrins, at least one sweetener and water.

According to a first embodiment, the waxy starch of the mixture is a native starch, i.e. a waxy starch still having its granular structure. According to this embodiment, the cooker used in the step of cooking the mixture is adapted by a person skilled in the art so that the gelatinization of the waxy starch takes place during said cooking step.

According to a second embodiment, the waxy starch of the mixture is a pregelatinized waxy starch, i.e. a starch that has undergone a heat treatment in the presence of water so that it loses almost all of its granular structure and becomes soluble in cold water.

According to a variant of this second embodiment, the pregelatinized waxy starch is provided as a premix with the branched maltodextrins. The premix thus comprises a pregelatinized waxy starch/branched maltodextrins weight ratio of from 1 to 8. Preferably, the pregelatinized waxy starch/branched maltodextrins weight ratio is from 2 to 6, more preferably from 3 to 5, and very particularly, it is approximately 4.

According to a particular embodiment, the method according to the invention comprises, after the step of shaping the cooked mixture, a step of recovering said gelled confectioneries.

According to another particular embodiment, the preparation process also further comprises a step of adding glucose syrup to the mixture comprising pregelatinized waxy starch and branched maltodextrins.

According to a particular embodiment, the process according to the invention may further comprise a step of adding a water activity regulating agent or depressant to the mixture before the cooking step. Sorbitol will then advantageously be taken, incorporated into the recipe in an amount of 2% to 3% by dry weight relative to the total weight of the final product.

Advantageously, by using waxy starch so as to replace gelatin in the gelled confectionery, the process according to the invention makes it possible to dispense with a prior hydration step characteristic of the processes for manufacturing gelatin-based gelled confectioneries.

The preparation process according to the invention also comprises a step of cooking the mixture comprising waxy starch, branched maltodextrins, at least one sweetener and water.

The duration of the cooking step is adapted by those skilled in the art and depends on the equipment used.

The cooking may be carried out on double-jacketed cookers at atmospheric pressure, under partial or total vacuum or under pressure, or continuously on high-pressure cookers such as tubular exchangers, plate exchangers or jet-cookers. The jet-cooker may comprise one or more steam injectors, thereby modifying the cooking times. Injection of live steam into the product provides rapid and homogeneous dispersion of the heat and of the ingredients. The tubular exchanger requires a homogeneous dispersion of all the ingredients before cooking, the cooking times are longer and the intensity less strong (cooker with scraped surface or cooking screw—atmospheric).

According to a particular embodiment of the invention, it is quite possible to envisage cooking the waxy starch separately then adding the other ingredients thereto, or preheating the sweetener before adding the waxy starch thereto, for example in the form of a 50% solids solution.

For a continuous production, it is preferred to disperse the sweeteners, the pregelatinized waxy starch, the branched maltodextrins and the regulating agent in a mixing tank, to preheat this mixture to approximately 70-80° C. in order to dissolve the sweeteners, to cook the mixture on a high-pressure cooker at a temperature of between 100° C. and 150° C. depending on the desired texture and the type of confectionery prepared, and then to add the fat, the emulsifier, the overrun agent(s), the flavors, the colorings, the active principles and the strong sweeteners.

According to a particular embodiment, the process according to the invention comprises a step of adding fat after the cooking step.

According to another particular embodiment, the process comprises a step of adding one or more compounds chosen from non-reducing sugars, fats, emulsifiers, preservatives, overrun agents, foaming agents, gelling agents, humectants, acidifying agents, natural or synthetic flavors, flavor enhancers, vitamins, pharmaceutical active agents, minerals such as calcium or magnesium and other food supplements such as, for example, DHA, natural or synthetic colorings, salts, acids, or various elements intended either to improve the quality, or to flavor the composition, such as dry fruits, candied fruits, fruits which have been dried or otherwise transformed (pressed, concentrated, powdered), and also fruit purees and fruit pulps. Preferably, the process comprises a step of adding one or more compounds chosen from emulsifiers and acids.

According to another particular embodiment, after cooking, the fat, the emulsifier or the overrun agent(s), the flavors, colorants, acids and the like are added to the hot syrup at a temperature between 60° C. and 90° C., the mixture is then poured onto a cooling plate, and stretched for about one minute at 50-60 movements (pulling is used for “long” textures, without initiation of crystallization or with initiation for “short”=crystallized textures).

Once the pulling has been carried out, the confectioneries obtained are shaped and wrapped.

According to this embodiment, as a first alternative, the fat can be added first if an emulsion is produced beforehand.

As a second alternative, instead of pulling, it is possible to perform vigorous mixing in a kneader in order to initiate crystallization (short texture).

The invention will be understood more clearly on reading the example which follows, which is intended to be illustrative and nonlimiting, making reference only to certain embodiments and certain advantageous properties according to the invention.

### EXAMPLE

### Preparation of Gelled Confectioneries According to the Invention

The objective is to produce gelled confectioneries of chewing paste type containing sugar according to the present invention but not containing gelatin.

In this example, chewing pastes were produced by incorporating in each new test variable proportions of pregelatinized waxy starch and of branched maltodextrins, and elasticity and hardness measurements of the chewing pastes thus obtained were carried out.

A—Formulations of the Various Gelled Confectioneries

The formulations used for the 10 tests are shown in table 1 below.

The pregelatinized waxy starch used is PREGEFLO® C100.

The branched maltodextrins used are NUTRIOSE® FM06.

The glucose syrup used is the C4280S glucose syrup sold by the applicant company.

The fat used is copra 24/26 fat.

Sucroesters are esters of sucrose and of fatty acids obtained by transesterification of methyl esters of sucrose, used as nonionic emulsifiers for fats, and sold by the company Stéarinerie Dubois (Boulogne, France).

TABLE 1

| | Test 1 | | Test 2 | | Test 3 | |
|---|---|---|---|---|---|---|
| | % solids | % solids | % solids | % solids | % solids | % solids |
| | relative | relative | relative | relative | relative | relative |
| | to final | to total | to final | to total | to final | to total |
| Ingredients | product | solids | product | solids | product | solids |
| Sucrose | 30.35 | 34.01 | 30.00 | 33.52 | 30.94 | 34.57 |
| C4280S glucose syrup | 51.341 | 57.525 | 42.42 | 47.40 | 49.49 | 55.29 |
| COPRA 24/26 | 3.83 | 4.29 | 3.84 | 4.29 | 3.84 | 4.29 |
| NUTRIOSE ® FM06 | 0.5 | 0.56 | 10 | 11.17 | 0 | 0 |
| PREGEFLO ® C100 | 2 | 2.23 | 2 | 2.23 | 4 | 4.47 |
| pregelatinized | | | | | | |
| waxy starch | | | | | | |
| Sucroester | 0.116 | 0.13 | 0.12 | 0.13 | 0.115 | 0.13 |
| Anhydrous citric acid | 0.64 | 0.72 | 0.64 | 0.72 | 0.6 | 0.72 |
| Strawberry flavor | 0.48 | 0.54 | 0.48 | 0.54 | 0.48 | 0.54 |
| Residual water | 10.75 | | 10.5 | | 10.5 | |
| | 100 | 100 | 100 | 100 | 100 | 100 |
| | Test 4 | | Test 5 | | Test 6 | |
| | % solids | % solids | % solids | % solids | % solids | % solids |
| | relative | relative | relative | relative | relative | relative |
| | to final | to total | to final | to total | to final | to total |
| Ingredients | product | solids | product | solids | product | solids |
| Sucrose | 30.44 | 34.01 | 30 | 33.52 | 29 | 32.40 |
| C4280S glucose syrup | 49.49 | 55.29 | 49.43 | 55.23 | 49.43 | 55.23 |
| COPRA 24/26 | 3.84 | 4.29 | 3.84 | 4.29 | 3.84 | 4.29 |
| NUTRIOSE ® FM06 | 0.5 | 0.56 | 1 | 1.12 | 2 | 2.23 |
| PREGEFLO ® C100 | 4 | 4.47 | 4 | 4.47 | 4 | 4.47 |
| pregelatinized | | | | | | |
| waxy starch | | | | | | |
| Sucroester | 0.115 | 0.13 | 0.115 | 0.13 | 0.115 | 0.13 |
| Anhydrous citric acid | 0.6 | 0.72 | 0.6 | 0.72 | 0.6 | 0.72 |
| Strawberry flavor | 0.48 | 0.54 | 0.48 | 0.54 | 0.48 | 0.54 |
| Residual water | 10.5 | | 10.5 | | 10.5 | |
| | 100 | 100 | 100 | 100 | 100 | 100 |
| | Test 7 | | Test 8 | | Test 9 | |
| | % solids | % solids | % solids | % solids | % solids | % solids |
| | relative | relative | relative | relative | relative | relative |
| | to final | to total | to final | to total | to final | to total |
| Ingredients | product | solids | product | solids | product | solids |
| Sucrose | 25.425 | 28.41 | 20.425 | 32.40 | 28.92 | 32.4 |
| C4280S glucose syrup | 45 | 50.28 | 46 | 55.23 | 46.785 | 52.420 |
| COPRA 24/26 | 3.84 | 4.29 | 3.84 | 4.29 | 3.83 | 4.29 |
| NUTRIOSE ® FM06 | 10 | 11.17 | 14 | 2.23 | 0.5 | 0.56 |
| PREGEFLO ® C100 | 4 | 4.47 | 4 | 4.47 | 8 | 8.90 |
| pregelatinized | | | | | | |
| waxy starch | | | | | | |
| Sucroester | 0.115 | 0.13 | 0.115 | 0.13 | 0.116 | 0.13 |
| Anhydrous citric acid | 0.6 | 0.72 | 0.6 | 0.72 | 0.64 | 0.72 |
| Strawberry flavor | 0.48 | 0.54 | 0.49 | 0.54 | 0.48 | 0.54 |
| Residual water | 10.5 | | 10.5 | | 10.75 | |
| | 100 | 100 | 100 | 100 | 100 | 100 |

Test 10

| Ingredients | Implementation | Final composition (%) |
|---|---|---|
| Sucrose | 24.99 | 28 |
| C4280S glucose syrup | 41.25 | 46.22 |
| COPRA 24/26 | 3.83 | 4.29 |
| NUTRIOSE ® FM06 | 10 | 11.17 |
| PREGEFLO ® C100 | 8 | 8.9 |
| pregelatinized | | |
| waxy starch | | |
| Sucroester | 0.12 | 0.13 |
| Anhydrous citric acid | 0.64 | 0.72 |
| Strawberry flavor | 0.48 | 0.54 |
| Residual water | 10.75 | |
| | 100 | 100 |

B—Process for Preparing the Gelled Confectionery:

Pour cold drinking water into a tank,

Introduce the pregelatinized waxy starch and the NUTRIOSE® with vigorous stirring,

After dispersion and verification of the absence of lumps, introduce the glucose syrup, still with stirring,

Then end with the addition of the sucrose.

Cook the preceding mixture at a predetermined temperature and at atmospheric pressure so as to obtain a mixture containing 90-94% solids. Generally, the cooking temperature is between 105° C. and 150° C. It is also possible to cook the preceding mixture under vacuum at a pressure of −0.5 bar. Mix well during the cooking step in order to prevent the mixture from burning.

After the cooking step, introduce the fat which has been melted at 50-60° C. or which has not been melted, with the emulsifier. Mix well.

Once the mass has cooled below 80° C., add the citric acid, then the flavor.

Pour the chewing paste onto a cooling table until it is at a temperature of between 50° C. and 60° C.

Pull the chewing paste for 1 minute (50 to 60 movements) so as to obtain good aeration. The aeration can also be obtained in a whipping machine under pressure (1 to 2 bar) in a continuous production process.

Leave the aerated chewing paste to stand in order for it to cool (between 45° C. and 55° C.) and in order for it to recover texture.

Shape, cut and optionally wrap the confectioneries.

C—Measurement Methods

For these various tests, the measurements were carried out on an INSTRON Texturometer, following the manufacturers specifications for measuring hardness and elasticity, in the following manner:

| | Measurement temperature: 20° C. |
|---|---|
| Texturometer: | INSTRON 9506 machine |
| Geometry: | “Finger punch” type |
| method: | Deformation imposed at |
| | 10 mm/min for 2 minutes at 30% |
| | of the height of the sample |

D—Results

The results are presented in table 2 below:

TABLE 2

| | | % of | | |
|---|---|---|---|---|
| | % pregelatinized | NUTRIOSE ® | | |
| | waxy starch | FM06 branched | Hardness | Elasticity |
| | PREGEFLO ® C100 | maltodextrins | (N) | (%) |
| Test 1 | 2 | 0.5 | 6.9 | 8 |
| Test 2 | 2 | 10 | 5.8 | 8 |
| Test 3 | 4 | 0 | 9.1 | 9.5 |
| Test 4 | 4 | 0.5 | 7.8 | 9 |
| Test 5 | 4 | 1 | 6.4 | 7 |
| Test 6 | 4 | 2 | 5.6 | 7 |
| Test 7 | 4 | 10 | 2.8 | 5 |
| Test 8 | 4 | 14 | 2.5 | 4 |
| Test 9 | 8 | 0.5 | 5.7 | 12 |
| Test 10 | 8 | 10 | 1.7 | 10 |

Taking into consideration the fact that the gelatin-free confectioneries according to the invention are of satisfactory quality and an optimum balance for intermediate hardness values between 6 and 8 N, and average elasticity values between 7% and 9%, it is deduced therefrom that for contents of 0.5% to 1.5%, more preferentially of about 1% of NUTRIOSE®, it is necessary to introduce an amount of 2% to 4% of pregelatinized waxy starch.

1. A gelatin-free gelled confectionery, comprising:
from 2% to 4% of pregelatinized waxy starch, and
from 0.5% to 1.5% of branched maltodextrins,
the percentages being expressed by dry weight relative to the total weight of the final product.

2. The confectionery as claimed in claim 2, characterized in that it comprises around 1% of maltodextrins, the percentage being expressed by dry weight relative to the total dry weight of the final product.

3. A premix of pregelatinized waxy starch and branched maltodextrins, said premix being characterized in that it comprises a pregelatinized waxy starch/branched maltodextrins weight ratio of 1 to 8.

4. The premix as claimed in claim 3, characterized in that said ratio is between from 3 to 5.

5. The premix as claimed in claim 4, characterized in that said ratio is around 4.

6. A gelatin-free confectioner, comprising the premix according to claim 3.

7. A process for preparing a gelatin-free gelled confectionary, comprising the steps of:
preparing a mixture comprising:
from 2% to 4% of waxy starch,
from 0.5% to 1.5% of branched maltodextrins, and
at least one sweetener and water,
cooking said mixture at a temperature of between 100° C. and 150° C. until the desired solids content is obtained, and
shaping the cooked mixture so as to obtain said gelled confectioneries.

8. The process as claimed in claim 7, characterized in that the waxy starch in the mixture is a pregelatinized waxy starch.
